(19) United States
(12) Patent Application Publication
(10) Pub. No.: US 2020/0130034 A1
(43) Pub. Date: Apr. 30, 2020

(54) ROLLING MILL DRIVE AND ASSOCIATED GEAR SPINDLE COUPLING

(71) Applicant: Xtek, Inc., Cincinnati, OH (US)

(72) Inventors: Mohamad DAHER, Edgewood, KY (US); Aaron DAMICO, Liberty Township, OH (US)

(21) Appl. No.: 16/597,981

(22) Filed: Oct. 10, 2019

Related U.S. Application Data
(60) Provisional application No. 62/750,288, filed on Oct. 25, 2018.

(51) Int. Cl. B21B 35/14; F16D 3/18

(52) U.S. Cl. CPC B21B 35/143; F16D 3/185

(57) ABSTRACT

A gear spindle coupling includes a spindle shaft having a driven end and a drive end, the drive end operatively connected to drive a hub gear that is located within a ring gear. The ring gear has an external diameter of at least 200 mm and an internal diameter of at least 100 mm, and the ring gear is of a steel material. The ring gear has a plurality of inwardly extending ring gear teeth. The hub gear is sized to fit within the ring gear and has a plurality of outwardly extending hub gear teeth, each of which is disposed between an adjacent pair of ring gear teeth. Each of the ring gear teeth includes oppositely facing flanks that are each crowned, and each of the hub gear teeth includes oppositely facing flanks that are each crowned.

### TECHNICAL FIELD

This application relates generally to industrial gear couplings and to a rolling mill drive arrangement and, more particularly, to a gear spindle coupling configuration for a rolling mill drive.

### BACKGROUND

Certain drive arrangements, such as rolling mill drives, utilize gear spindle couplings to drive the work roll. In one known arrangement, a rolling mill gear spindle coupling has a roll end hub gear with crowned gear teeth and an involute profile, and a roll end ring gear that includes gear teeth that have planar flanks. In this known arrangement, the rotational center point of the hub gear can also move slightly axially (i.e., left to right in the FIG. 1 cross-section) as the operating angle departs from the optimal 0 degrees. The result, caused by both the gear tooth form and the permitted axial movement of the hub gear, is that the percentage of teeth in contact between the hub gear and the ring gear quickly drops as the operating angle departs from 0 degrees, reducing the load capability of the gear spindle coupling.

It would be desirable to provide a gear spindle coupling with better performance characteristics, such as loading capability.

### SUMMARY

A. In one aspect, a gear spindle coupling includes a spindle shaft having a driven end and a drive end, the drive end operatively connected to drive a hub gear that is located within a ring gear. The ring gear has an external diameter of at least 200 mm and an internal diameter of at least 100 mm, and the ring gear is of a steel material. The ring gear has a plurality of inwardly extending ring gear teeth. The hub gear is sized to fit within the ring gear and has a plurality of outwardly extending hub gear teeth, each of which is disposed between an adjacent pair of ring gear teeth. Each of the ring gear teeth includes oppositely facing flanks that are each crowned, and each of the hub gear teeth includes oppositely facing flanks that are each crowned.

B. The gear spindle coupling of paragraph A, wherein each of the ring gear teeth includes oppositely facing flanks that are of concave curved profile, and wherein each of the hub gear teeth includes oppositely facing flanks that are of convex curved profile.

C. The gear spindle coupling of paragraph B where the concave curved profile is defined by a first radius and the convex curved profile is defined by a second radius, wherein the first radius is substantially the same as the second radius.

D. The gear spindle coupling of any paragraphs A, B or C wherein a shape of the crown on each flank of each ring gear tooth is defined by a third radius and a shape of the crown on each flank of each hub gear tooth is defined by a fourth radius, wherein the third radius is substantially the same as the fourth radius.

E. The gear spindle coupling of any of paragraph A through D, wherein the steel material of the ring gear, at least on oppositely facing flanks of each of the ring gear teeth, has a surface hardness of at least 50 HRC, such as at least 55 HRC.

F. The gear spindle coupling of any of paragraphs A through E, including a spherical thrust plate located at a first side of the ring gear, and a spherical retainer located at a second side of the ring gear. Wherein the hub gear is formed with a first part spherical surface portion on the first side and a second part spherical surface portion on the second side, wherein the first part spherical surface portion engages a part spherical surface portion on the spherical thrust plate, wherein the second part spherical surface portion engages a part spherical surface portion on the spherical retainer.

G. The gear spindle coupling of paragraph F, further comprising: a seal package disposed on a spindle shaft side of the spherical retainer; and a ring plate at an external side of the seal package, the ring plate secured to the ring gear by a plurality of bolts that pass through aligned openings in the seal package, the spherical retainer and the ring gear.

H. The gear spindle coupling of any of paragraphs A through G, wherein the ring gear has an external diameter of at least 400 mm and an internal diameter of at least 200 mm.

I. The gear spindle coupling of any of paragraphs A through H, wherein the ring gear has a weight of at least forty kilograms.

The features of any of paragraphs A through I above could likewise be incorporated into another type of gear coupling that does not include the spindle shaft specified in paragraph A.

J. In another aspect, a gear spindle coupling, comprises: a spindle shaft having a driven end and a drive end, the drive end operatively connected to drive a hub gear that is located within a ring gear; wherein the ring gear has a plurality of inwardly extending ring gear teeth; wherein the hub gear is sized to fit within the ring gear and has a plurality of outwardly extending hub gear teeth, each of which is disposed between an adjacent pair of ring gear teeth; wherein each of the ring gear teeth includes oppositely facing flanks that are each crowned; wherein each of the hub gear teeth includes oppositely facing flanks the are each crowned; wherein the hub gear includes a rotational center point that is axially fixed.

K. The gear spindle coupling of paragraph J, wherein each of the ring gear teeth includes oppositely facing flanks that are of concave arcuate profile; wherein each of the hub gear teeth includes oppositely facing flanks that are of convex arcuate profile.

L. The gear spindle coupling of paragraph J or K, wherein a shape of the crown on each flank of each ring gear tooth is defined by a first radius and a shape of the crown on each flank of each hub gear tooth is defined by a second radius, wherein the first radius is substantially the same as the second radius.

The features of any of paragraphs J through L above could likewise be incorporated into another type of gear coupling that does not include the spindle shaft specified in paragraph J.

M. In a further aspect, a gear coupling, comprises: a hub gear that is located within a ring gear; wherein the ring gear has an external diameter of at least 200 mm and an internal diameter of at least 100 mm, and the ring gear is of a steel material; wherein the ring gear has a plurality of inwardly extending ring gear teeth; wherein the hub gear is sized to fit within the ring gear and has a plurality of outwardly extending hub gear teeth, each of which is disposed between an adjacent pair of ring gear teeth; wherein each of the ring gear teeth includes oppositely facing flanks that are each crowned; wherein each of the hub gear teeth includes oppositely facing flanks the are each crowned.

N. The gear coupling of paragraph M, wherein each of the ring gear teeth includes oppositely facing flanks that are of concave arcuate profile; wherein each of the hub gear teeth includes oppositely facing flanks that are of convex arcuate profile.

O. The gear coupling of paragraph M or N, wherein a shape of the crown on each flank of each ring gear tooth is defined by a first radius and a shape of the crown on each flank of each hub gear tooth is defined by a second radius, wherein the first radius is substantially the same as the second radius.

P. The gear coupling of any of paragraphs M through O, wherein the steel material of the ring gear, at least on oppositely facing flanks of each of the ring gear teeth, has a surface hardness of at least 50 HRC.

Q. The gear coupling of any of paragraphs M through P, further comprising: a spherical thrust plate located at a first side of the ring gear; a spherical retainer located at a second side of the ring gear; wherein the hub gear is formed with a first part spherical surface portion on the first side and a second part spherical surface portion on the second side, wherein the first part spherical surface portion engages a part spherical surface portion on the spherical thrust plate, wherein the second part spherical surface portion engages a part spherical surface portion on the spherical retainer.

R. The gear coupling of paragraph Q further comprising: a seal package disposed on a spindle shaft side of the spherical retainer; and a ring plate at an external side of the seal package, the ring plate secured to the ring gear by a plurality of bolts that pass through aligned openings in the seal package, the spherical retainer and the ring gear.

S. The gear coupling of any of paragraphs M through R, wherein the ring gear has an external diameter of at least 400 mm and an internal diameter of at least 200 mm.

T. The gear coupling of any of paragraphs M through S, wherein the ring gear has a weight of at least forty kilograms.

U. In yet another aspect, a gear spindle coupling includes a spindle shaft having a driven end and a drive end, the drive end operatively connected to drive a hub gear that is located within a ring gear. The ring gear and hub gear are of a steel material. The ring gear has a plurality of inwardly extending ring gear teeth. The hub gear is sized to fit within the ring gear and has a plurality of outwardly extending hub gear teeth, each of which is disposed between an adjacent pair of ring gear teeth. Each of the ring gear teeth includes oppositely facing flanks that are each crowned, and each of the hub gear teeth includes oppositely facing flanks that are each crowned.

### BRIEF DESCRIPTION OF THE DRAWINGS

FIG. 1 is a plan view of one embodiment of a rolling mill drive;

FIG. 2 is a perspective view of the roll end of a gear spindle coupling;

FIG. 3 is a cross-section of the perspective FIG. 2;

FIG. 4 shows the cross-section in side elevation;

FIGS. 5 and 6 are exploded partial perspectives, in cross-section, showing hub gear, ring gear, spherical thrust plate and spherical retainer plate;

FIG. 7 is an enlarged partial cross-section depicting an operating angle offset from zero degrees;

FIG. 8 is a partial perspective of the hub gear depicting the hub gear tooth form;

FIG. 9 is a partial perspective of the ring gear depicting the ring gear tooth form;

FIG. 10 schematically depicts a hub gear tooth between two adjacent ring gear teeth;

FIG. 11 shows a representation of hub gear tooth to ring gear tooth contact in the inventive coupling;

FIG. 12 shows a representation of hub gear tooth to ring gear tooth contact in a conventional coupling;

FIG. 13 is a cross-section showing both ends of the gear spindle coupling;

FIG. 14 is an end view of the hub gear;

FIG. 15 is an end view of the ring gear;

FIG. 16 is a cross-section of a hub gear tooth along line A-A of FIG. 13;

FIG. 17 is a cross-section of a ring gear tooth along line A-A of FIG. 13;

FIG. 18 shows interacting ring gear and hub gear teeth in cross-section;

FIG. 19 is a cross-section view along line B-B of FIG. 14;

FIG. 20 is a cross-section view along line C-C of FIG. 15.

### DETAILED DESCRIPTION

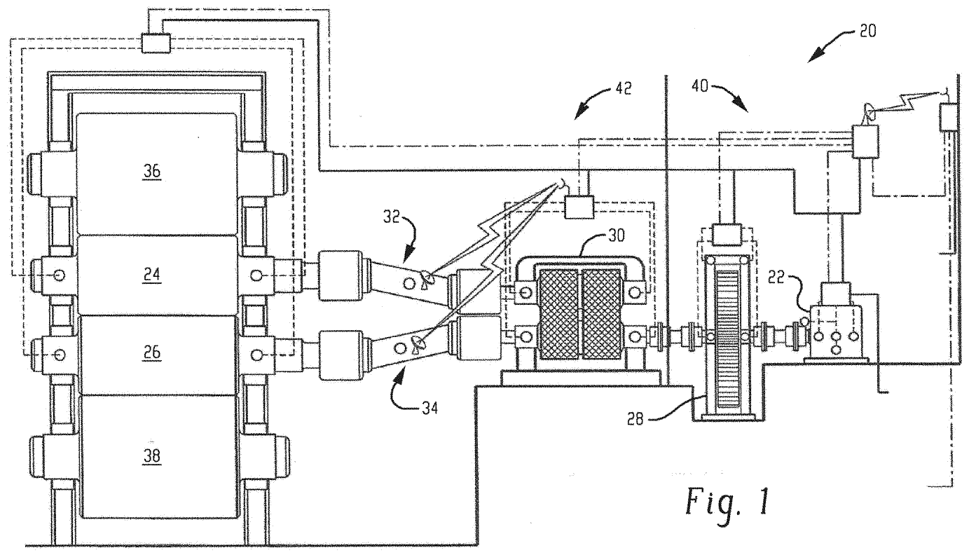

Reference is made to FIG. 1 showing an exemplary rolling mill drive arrangement with a drive train 20, e.g., for use in rolling metal such as steel. Rolling mill drive train 20 includes a motor 22 that is operatively connected to work rolls 24 and 26 through a drive train power transmission that includes a gear reducer 28, pinion assembly 30 and gear spindle couplings 32 and 34. Backup rolls 36 and 38 are located adjacent to and contact the work rolls 24 and 26 to form a nip through which a work piece (e.g., a metal plate) is fed during a rolling operation. The motor 22 and gear reducer 28 may be located in a motor room portion 40 of a mill, while the pinion assembly 30, gear spindle couplings 32, 34, work rolls 24, 26 and backup rolls 36, 38 are located in a mill portion 42 separated from the motor room portion 40.

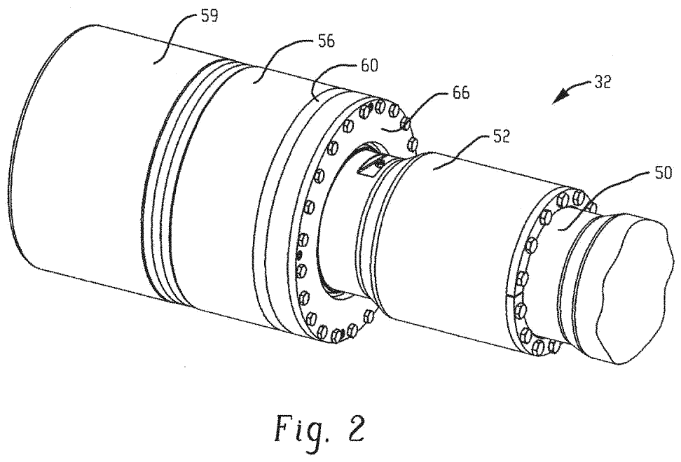

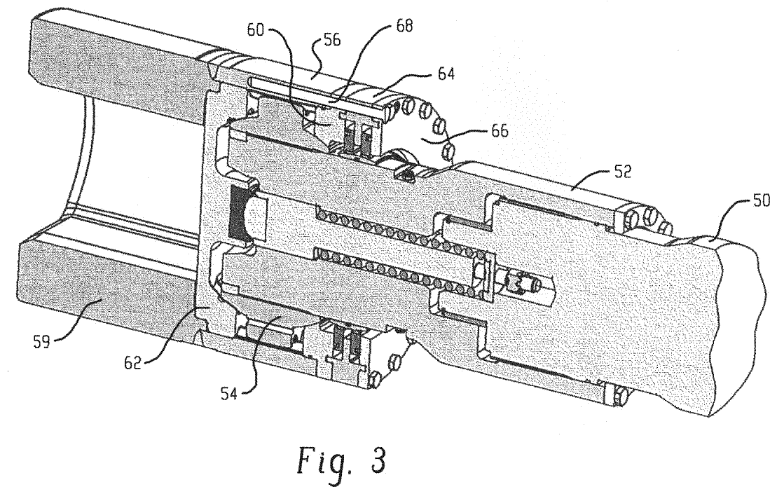

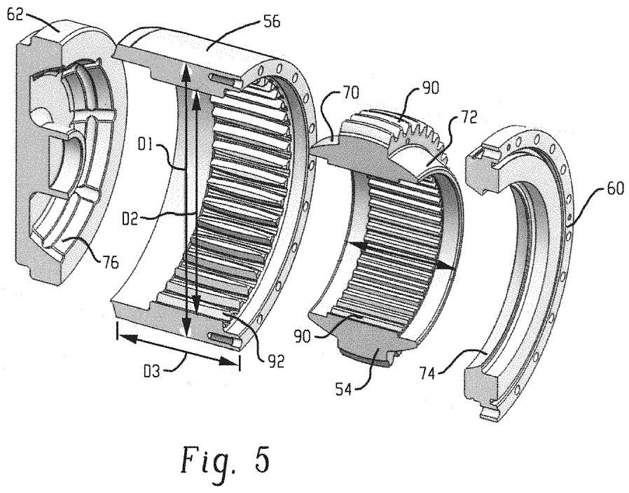

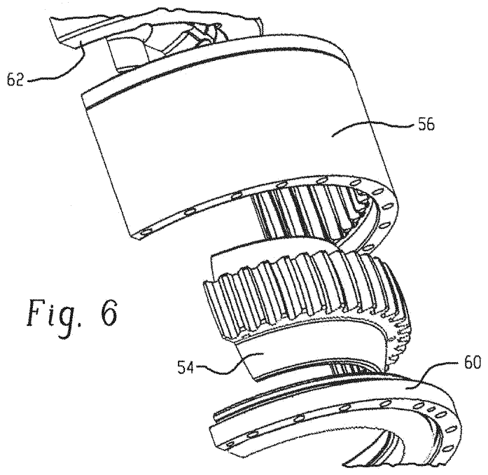

Referring to FIGS. 2-7, the roll end portion of an exemplary gear spindle coupling 32 is shown and includes a spindle shaft 50, spline adapter 52, hub gear 54 and ring gear 56. A spherical thrust plate 62 is located at one side of the ring gear 56 and a spherical retainer 60 is located at the opposite side of the ring gear. A seal package 64 is disposed on the spindle shaft side of the spherical retainer 60 and is held in place by a ring plate 66, with bolts 68 that pass through aligned openings in the seal package 64 and spherical retainer then into the ring gear 56. The ring gear 56 couples with a roll end casing 59.

The hub gear 54 includes opposite sides that define outwardly facing surfaces 70 and 72 formed as partial spheres. The spherical retainer 60 defines an inwardly facing surface 74 formed as a partial sphere, and the spherical thrust plate 62 defines and inwardly facing surface 76 formed as a partial sphere. Surfaces 72 and 74 interact, and surfaces 70 and 76 interact, in each case by relative sliding along each other, in a manner that enables the hub gear 54 to rotate slightly within the ring gear 56 during operation to account for variations in position of the work roll being driven, with a rotational center point 78 of the hub gear 54 remaining at a fixed location relative to the ring gear 56. The rotational center point 78 is also located along the center axis 79 of the spindle shaft 50. Potential axial movement of the spindle shaft 50 is accommodated by a centrally disposed spring guide assembly 80 having an end located bearing element 82 with convex bearing surface that is part spherical and that seats against a concave bearing surface of a bearing element 84 seated in the center of the spherical thrust plate 62. This configuration prevents axial movement of the center point 78 out of or along the axial depth of the ring gear 56.

A typical ring gear 56 in the above-described system may have an external diameter D1 of at least 200 mm, such as at least 400 mm or in the range of between about 200 mm and about 1750 mm (such as 400 mm to 1750 mm), an internal diameter D2 (e.g., defined between diametrically opposite gear teeth top lands or defined by an imaginary circle that follows the gear teeth top lands) of at least 100 mm, such as at least 200 mm or in the range of between about 100 mm and about 1350 mm (such as 200 mm to 1350 mm), and an axial or longitudinal depth D3 of at least 200 mm, such as between about 200 mm and about 800 mm, but other variations are possible. Such a ring gear 56 may typically be formed of a steel material having a surface hardness of at least 50 HRC (e.g., at least 55 HRC, such as between 55 HRC and 62 HRC), and may weight have a weight of at least 40 kilograms, such as at least 100 kilograms, at least 200 kilograms or between about 40 kilograms and about 4500 kilograms. The hub gear is sized to achieve fit with the ring gear, and may be formed of similar material with similar hardness.

The hub gear 54 includes outwardly extending gear teeth 90 that engage with and drive against inwardly extending gear teeth 92 of the of the ring gear 56. The spline adaptor 52 is splined to the internal portion of the hub gear 54, and the end of the spindle shaft 50 is splined internally of the spline adapter 52. In this manner, rotation of the spindle shaft 50 causes rotation of the spline adaptor 52, which in turn causes rotation of the hub gear 54, which in turn causes rotation of the ring gear 56, which in turn causes rotation of the roll end casing 59.

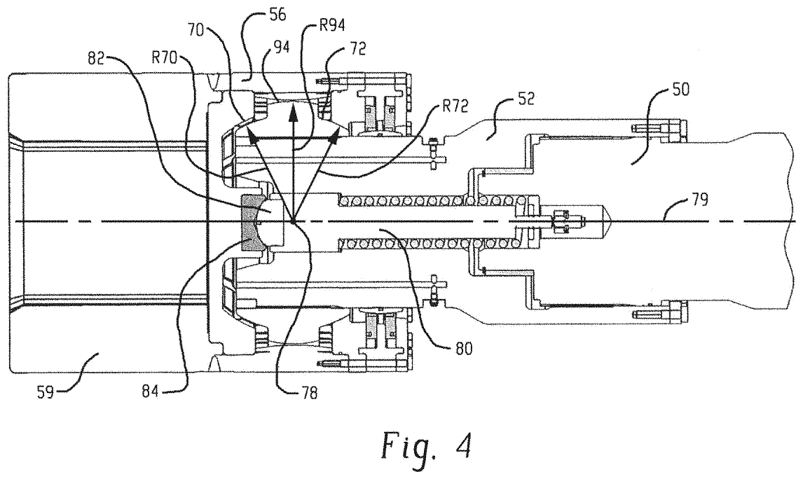

In one implementation of the above rolling mill drive, the gear teeth 90 of the hub gear 54 have top land areas 94 that are also curved in at least the axial direction (i.e., left to right or right to left in FIG. 4), and which are preferably surfaces that are partial spheres. In such cases, the radii R70 and R72 of the surfaces 70 and 72 and the radius R94 of the top land surface 92 all intersect the center point 78.

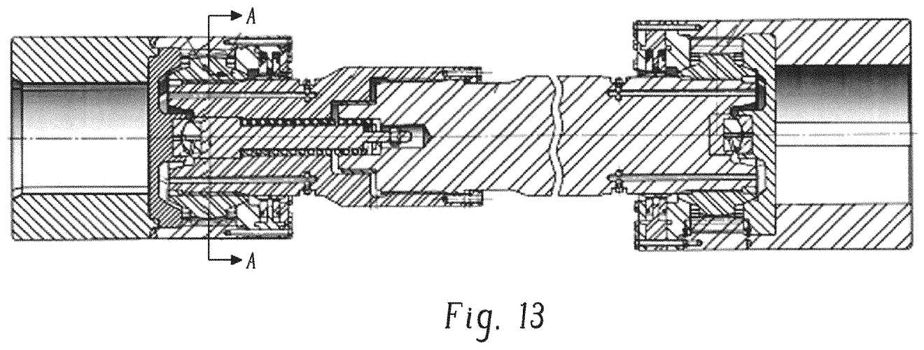

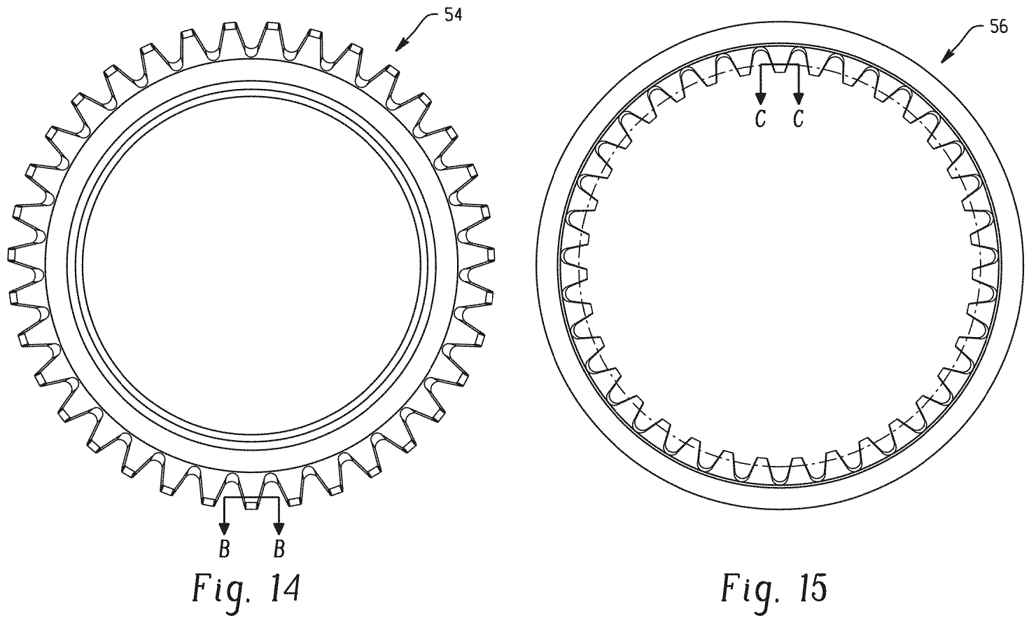

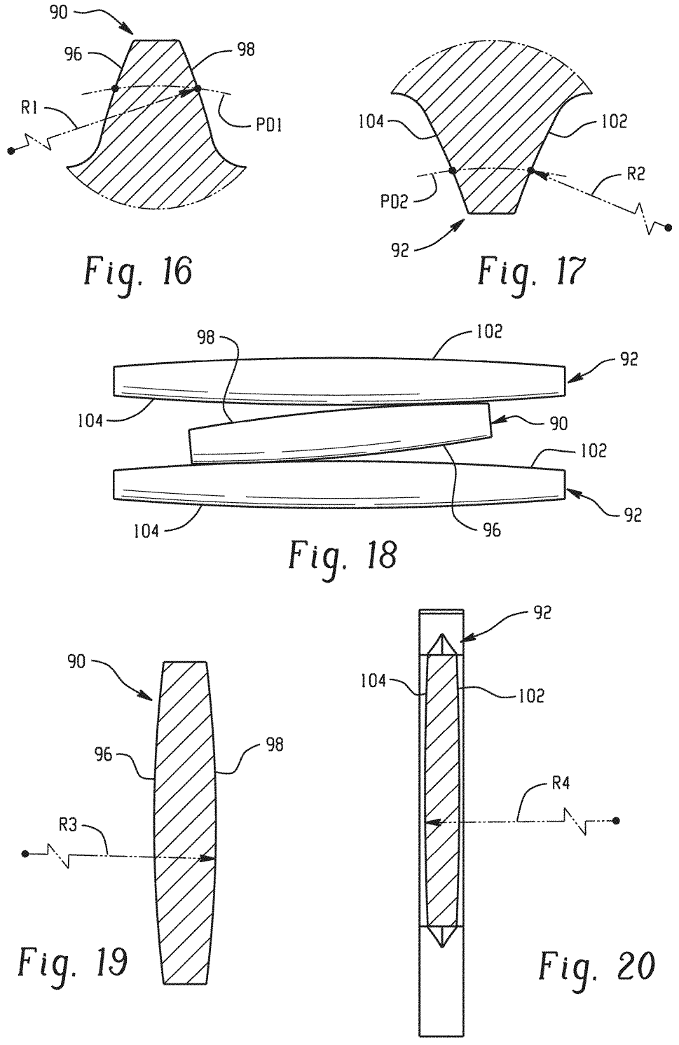

The shape of the flanks on each gear tooth can also be important to overall performance of the hub gear to ring gear connection. Two features of the flank shape are generally considered, namely the shape of the flank when moving radially along the height of the tooth and the shape of the flank when moving longitudinally along the length of the tooth. The shape of the flank when moving radially along the height of the tooth is referred to as the flank profile and is considered by taking a cross-section of the tooth along a plane that is orientated perpendicular to the center axis of the gear (e.g., along section plane A-A in FIG. 13 for both the hub gear and the ring gear). Typically this cross-section is taken at the mid-point along the length of the tooth face. The shape of the flank when moving longitudinally along the length of the tooth is considered by taking a cross-section along a plane that is perpendicular to a radius line or plane that runs from the center axis of the gear and through the center of the gear tooth width (e.g., along section plane B-B for the hub gear per FIG. 14 or along section plane C-C for the ring gear per FIG. 15). Typically this cross-section is taken at the pitch diameter of the tooth (e.g., see pitch diameters PD1 and PD2 in FIGS. 16 and 17).

In the preferred implementation of the present gear spindle coupling, as per FIGS. 16-18, the oppositely facing flanks 96 and 98 of each gear tooth 90 on the ring gear are both longitudinally crowned. Likewise, each inwardly extending gear tooth 92 of the ring gear 56 has oppositely facing flanks 102 and 104 (FIG. 9) that are longitudinally crowned. The crown of the flanks on each gear tooth, whether of the hub gear or the ring gear, is a convex crown and may beneficially be defined by an arc of a specific radius R3 or R4, which may be between about 250 mm and about 2500 mm, though other variations are possible. The radius of the arc defining the crown on opposite sides of the same gear tooth is the same. Moreover, for the interacting hub gear and ring gear of a given gear spindle coupling, typically the radius R3 will be substantially the same as the radius R4.

In general, crowning, in the context of the gear tooth flanks, results in a gear tooth that is wider at a midpoint 110 along an axis 112 of the gear tooth than at points (e.g., such as 114, 116) near the axial ends of the gear tooth. Thus, at a given radial height along the gear tooth, the width of the gear tooth at that height gradually decreases when moving from the midpoint 110 towards either tooth end.

In the preferred implementation of the present gear spindle coupling, the flanks 96 and 98 (FIGS. 8 and 16) of each gear tooth 90 on the hub gear are both circular in flank profile and the flanks 102 and 104 (FIGS. 9 and 17) of each gear tooth 92 on the ring gear are both circular in flank profile. In particular, the profile of each flank 96, 98 is convex and is defined by an arc of a specific radius R1, and the profile of each flank 102, 104 is concave and is defined by an arc of a specific radius R2. Each flank 96, 98 has a profile arc with the same radius R1, where the radius R1 may typically be between about 125 mm and about 1250 mm, such as at least 250 mm, though other variations are possible. Likewise, each flank 102, 104 has a profile arc with the same radius R2, where the radius R2 may typically be between about 125 mm and about 1250 mm, such as at least 250 mm, though other variations are possible. For the interacting hub gear and ring gear of a given gear spindle coupling, the radius R1 will be substantially the same as the radius R2.

For the purpose of symmetry, the hub gear and ring gear at the opposite end of the gear spindle coupling will typically have the same configuration as that described above for the roll end.

The axially fixed rotational center point 78, in combination with the above-described preferred shape of hub gear teeth 90 and ring gear teeth 92, provides for improved contact between the hub gear teeth 90 and the ring gear teeth 92.

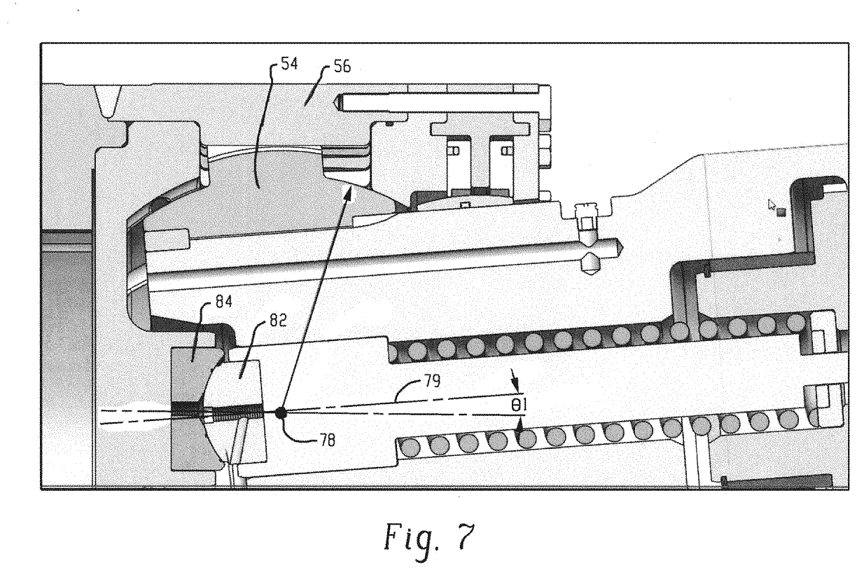

More specifically, a relative position between the hub gear axis 79 and the ring gear axis 81 (FIG. 7) defines an operating angle θ1 between the two gears. When axis 79 and axis 81 are aligned/collinear (the position of FIG. 4) the operating angle θ1 is zero degrees. When the hub gear 54 begins to tilt relative to the ring gear 56, the operating angle θ1 departs from zero as shown in FIG. 7. Table 1 below, which assumes a ring gear having an external diameter of 665 mm and internal diameter of 540 mm, where the ring gear and the hub gear each have 35 teeth, demonstrates the beneficial impact of fixing the rotational center point of the hub gear.

TABLE 1
Percentage of Teeth in Contact

| | Operating Angle θ1 | | |
|---|---|---|---|
| | 1.5° | 3.0° | 5.0° |
| Conventional | 45-50% | 30-35% | 15-20% |
| (Rotational Center | | | |
| Point Not Fixed) | | | |
| Improved | 100% | 100% | 50-55% |
| (Rotational Center | | | |
| Point Fixed) | | | |

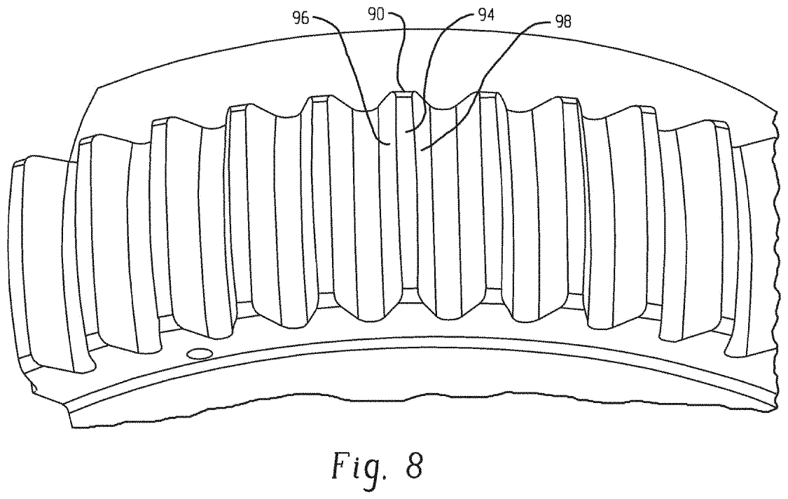

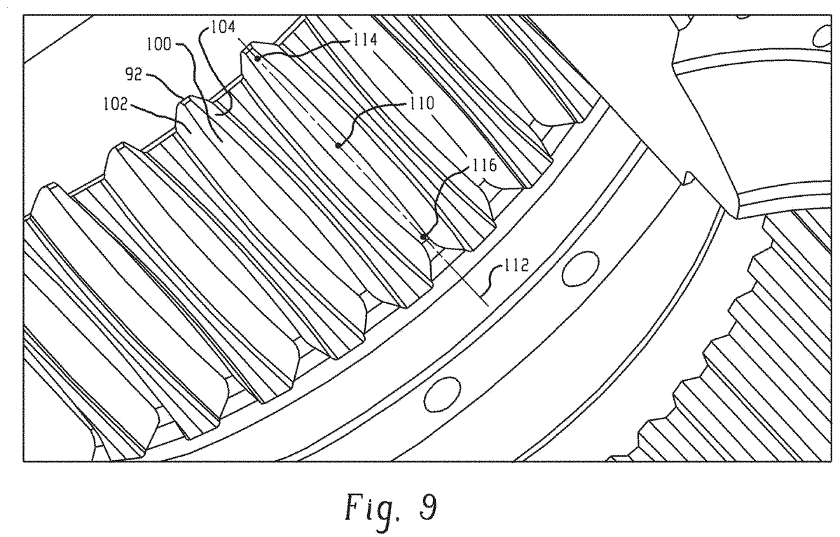

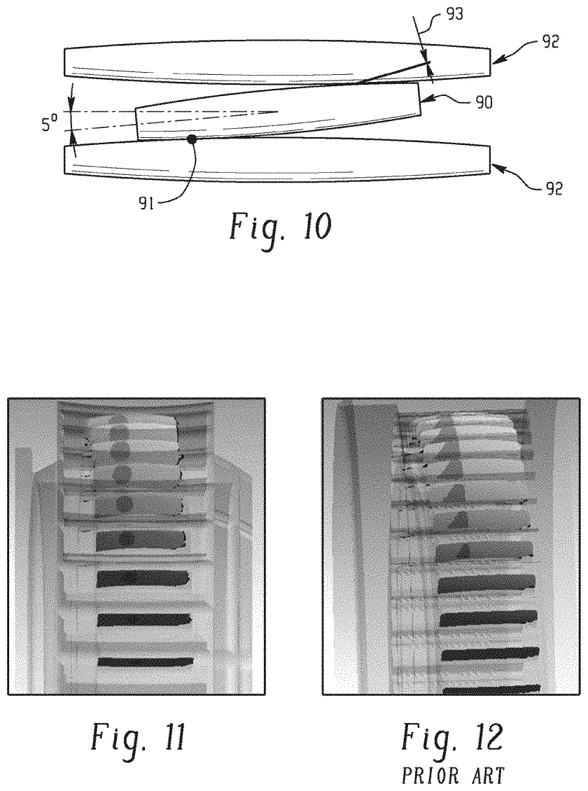

FIG. 10 represents an exemplary hub gear tooth 90 interacting with adjacent ring gear teeth 92 at an operating angle of five degrees, with contact point 91 shown and backlash spacing 93 shown. The preferred flank configuration of hub gear teeth 90 and ring gear teeth 92 provides for more effective contact between the teeth 90 and 92, as reflected in the comparative contact representations shown in FIGS. 11 and 12. Note that the contact shown in FIG. 11 (for the inventive configuration) starts at the middle of the tooth flank and spreads outward in all directions keeping contact stress to minimal, whereas the contact shown in FIG. 12 (for the conventional configuration) starts at the inner diameter of the ring gear resulting in a line edge contact producing the highest stress that the ring gear experiences.

The preferred configuration of fixed hub gear rotational center point, hub gear teeth flank shape and ring gear teeth flank shape provides an arrangement that is capable of higher loads because it promotes more teeth in contact at higher angles and keeps the stress within material allowable limits.

The ring gear and hub gear are formed of a steel material, more specifically a forged alloy steel, and the teeth may be cut using a form grinder before and after the heat treatment process.

It is to be clearly understood that the above description is intended by way of illustration and example only and is not intended to be taken by way of limitation, and that changes and modifications are possible. For example, while the above arrangement is described primarily in the context of a gear spindle coupling for a rolling mill, uses in other systems are possible. Moreover, the described hub gear and ring gear features could be incorporated into other industrial gear couplings, such as those used for connections between the motor and gear reducer 28 or the gear reducer and pinon assembly 30 in FIG. 1.

What is claimed is:

1. A gear spindle coupling, comprising:
a spindle shaft having a driven end and a drive end, the drive end operatively connected to drive a hub gear that is located within a ring gear;
wherein the ring gear has an external diameter of at least 200 mm and an internal diameter of at least 100 mm, and the ring gear is of a steel material;
wherein the ring gear has a plurality of inwardly extending ring gear teeth;
wherein the hub gear is sized to fit within the ring gear and has a plurality of outwardly extending hub gear teeth, each of which is disposed between an adjacent pair of ring gear teeth;
wherein each of the ring gear teeth includes oppositely facing flanks that are each crowned;
wherein each of the hub gear teeth includes oppositely facing flanks that are each crowned.

2. The gear spindle coupling of claim 1,
wherein each of the ring gear teeth includes oppositely facing flanks that are of concave curved profile;
wherein each of the hub gear teeth includes oppositely facing flanks that are of convex curved profile.

3. The gear spindle coupling of claim 2 where the concave curved profile is defined by a first radius and the convex curved profile is defined by a second radius, wherein the first radius is substantially the same as the second radius.

4. The gear spindle coupling of claim 3 wherein a shape of the crown on each flank of each ring gear tooth is defined by a third radius and a shape of the crown on each flank of each hub gear tooth is defined by a fourth radius, wherein the third radius is substantially the same as the fourth radius.

5. The gear spindle coupling of claim 2 wherein the steel material of the ring gear, at least on oppositely facing flanks of each of the ring gear teeth, has a surface hardness of at least 50 HRC.

6. The gear spindle coupling of claim 1, further comprising:
a spherical thrust plate located at a first side of the ring gear;
a spherical retainer located at a second side of the ring gear;
wherein the hub gear is formed with a first part spherical surface portion on the first side and a second part spherical surface portion on the second side, wherein the first part spherical surface portion engages a part spherical surface portion on the spherical thrust plate, wherein the second part spherical surface portion engages a part spherical surface portion on the spherical retainer.

7. The gear spindle coupling of claim 6, further comprising:
a seal package disposed on a spindle shaft side of the spherical retainer; and
a ring plate at an external side of the seal package, the ring plate secured to the ring gear by a plurality of bolts that pass through aligned openings in the seal package, the spherical retainer and the ring gear.

8. The gear spindle coupling of claim 1 wherein the ring gear has an external diameter of at least 400 mm and an internal diameter of at least 200 mm.

9. The gear spindle coupling of claim 1 wherein the ring gear has a weight of at least forty kilograms.

10. A gear spindle coupling, comprising:
a spindle shaft having a driven end and a drive end, the drive end operatively connected to drive a hub gear that is located within a ring gear;
wherein the ring gear has a plurality of inwardly extending ring gear teeth;
wherein the hub gear is sized to fit within the ring gear and has a plurality of outwardly extending hub gear teeth, each of which is disposed between an adjacent pair of ring gear teeth;
wherein each of the ring gear teeth includes oppositely facing flanks that are each crowned;
wherein each of the hub gear teeth includes oppositely facing flanks the are each crowned;
wherein the hub gear includes a rotational center point that is axially fixed.

11. The gear spindle coupling of claim 10,
wherein each of the ring gear teeth includes oppositely facing flanks that are of concave arcuate profile;
wherein each of the hub gear teeth includes oppositely facing flanks that are of convex arcuate profile.

12. The gear spindle coupling of claim 11 wherein a shape of the crown on each flank of each ring gear tooth is defined by a first radius and a shape of the crown on each flank of each hub gear tooth is defined by a second radius, wherein the first radius is substantially the same as the second radius.

13. A gear coupling, comprising:
a hub gear that is located within a ring gear;
wherein the ring gear has an external diameter of at least 200 mm and an internal diameter of at least 100 mm, and the ring gear is of a steel material;
wherein the ring gear has a plurality of inwardly extending ring gear teeth;
wherein the hub gear is sized to fit within the ring gear and has a plurality of outwardly extending hub gear teeth, each of which is disposed between an adjacent pair of ring gear teeth;
wherein each of the ring gear teeth includes oppositely facing flanks that are each crowned;
wherein each of the hub gear teeth includes oppositely facing flanks the are each crowned.

14. The gear coupling of claim 13,
wherein each of the ring gear teeth includes oppositely facing flanks that are of concave arcuate profile;
wherein each of the hub gear teeth includes oppositely facing flanks that are of convex arcuate profile.

15. The gear coupling of claim 14 wherein a shape of the crown on each flank of each ring gear tooth is defined by a first radius and a shape of the crown on each flank of each hub gear tooth is defined by a second radius, wherein the first radius is substantially the same as the second radius.

16. The gear coupling of claim 13 wherein the steel material of the ring gear, at least on oppositely facing flanks of each of the ring gear teeth, has a surface hardness of at least 50 HRC.

17. The gear coupling of claim 13, further comprising:
a spherical thrust plate located at a first side of the ring gear;
a spherical retainer located at a second side of the ring gear;
wherein the hub gear is formed with a first part spherical surface portion on the first side and a second part spherical surface portion on the second side, wherein the first part spherical surface portion engages a part spherical surface portion on the spherical thrust plate, wherein the second part spherical surface portion engages a part spherical surface portion on the spherical retainer.

18. The gear coupling of claim 17, further comprising:
a seal package disposed on a spindle shaft side of the spherical retainer; and
a ring plate at an external side of the seal package, the ring plate secured to the ring gear by a plurality of bolts that pass through aligned openings in the seal package, the spherical retainer and the ring gear.

19. The gear coupling of claim 13 wherein the ring gear has an external diameter of at least 400 mm and an internal diameter of at least 200 mm.

20. The gear coupling of claim 13 wherein the ring gear has a weight of at least forty kilograms.

21. The gear coupling of claim 13, wherein the gear coupling is a gear spindle coupling that includes a spindle shaft having a driven end and a drive end, the drive end operatively connected to drive the hub gear.
